(19) United States
(12) Patent Application Publication
(10) Pub. No.: US 2012/0168430 A1
(43) Pub. Date: Jul. 5, 2012

(54) Grounded Film Type Heater

(75) Inventor: Tae S. Seo, Hamilton (NZ)

(73) Assignee: WARM WAVES, LLC

(21) Appl. No.: 12/982,661

(22) Filed: Dec. 30, 2010

(51) Int. Cl. H05B 3/34; H05B 3/02; B82Y 30/00

(52) U.S. Cl. 219/549; 219/546; 977/742

(57) ABSTRACT

The invention provides a film-type heater with improved stability having an upper component comprising a first outer covering and a first intermediate layer; a lower component comprising a second outer covering and a second intermediate layer; and at least one carbon containing heating element attached to means for applying electrical current which is disposed between said upper component and said lower component wherein the heater further includes an electrical grounding element comprising a carbon containing conductor disposed between said carbon containing heating element and at least one of said upper component or lower component.

### BACKGROUND OF THE INVENTION

The present invention is related to electrical film-type heaters and more specifically to improved heaters which are grounded. The heaters of the invention provide improved safety characteristics and more specifically increase the flexibility of the grounding and the overall and film heater which reduces electric, magnetic and electromagnetic damage. The improved heaters can be used to heat living spaces and can also be used on bed furniture or clothing where it is desired that the heater be grounded so as to provide increased flexibility and reduce the risk of shock and electrical fire hazard.

The invention relates to film heaters which provide heat through resistance to electrical current. Such heaters do not create air pollution, are easy to control and silent. As such they may be used to provide heat and prevent icing in commercial and residential heating systems and may also be used to heat mattresses, beds and cushions. Such systems can be used in commercial buildings such as offices and stores for general heating. They may also be used for industrial uses such as in warehouses, manufacturing facilities and the like. The systems may also be used in agricultural operations such as anti-freeze systems, in green houses and in livestock housing. The systems may also be applied to other uses where it is desired to prevent freezing or fogging.

The plate-type heaters of the prior art comprise an upper component comprising a first outer covering, and a first intermediate layer joined together, a lower component composed of a second outer covering and a second intermediate layer joined together, a carbon compound placed between the upper component and the lower component, and wires fusion-bonded to the surface of the heat-generating layer. In this case, the carbon compound converts electrical energy to thermal energy, thus emitting far infrared rays.

In this construction the first intermediate layer and the second intermediate layer act as the primary components blocking electricity from the heat-generating carbon compound and maintaining the original shape of the device, thus constituting a kind of insulating material for improving printing of the carbon compound. On the other hand, the first outer covering and the second outer covering act as the secondary components blocking electricity coming from the carbon compound and maintaining the original shape of the device, and they form an outer covering of polyolefin class material whose surface is printable. Wires are fixed in place on the current-carrying film (current-carrying wire) solely by lamination without using an adhesive. Wires may be flat strips of a conductive material, such as copper or may be braided wires which are pressed to a substantially flat shape.

The film heaters of the prior art are produced stepwise by applying multiple layers from a bottom to a top layer. Each layer is fully dried after it is added. Once the film is dried a laminated braided wire is inserted which is held in place by dry laminating method. FIG. 1 is the section view of traditional film heater according to Korean Patent No. 10-0860258 (the disclosure of which is incorporated by reference) which also describes a method of fabrication.

FIG. 1 depicts a traditional film heater comprising a first plastic film (10) used as first outer layer; a first conductive carbon containing (carbonic) heating layer (11) which is located on top of first plastic film (10); multiple copper wires (12) which are connected to a source of electrical covered by the first carbonic heating layer (11) from side and bottom; non-woven fabric layer (13) which is located above first carbonic heating layer (11) and covering the nearest two copper wires (12); a second carbonic layer (14) located above non-woven fabric layer (13), and second plastic film (15) which is located above second carbonic heating layer (14) which is also used as second outer layer. The conductive carbon heating layer of Korean Patent No. 10-0860258 comprises 15-17% by weight carbon powder, 1-2% by weight germanium, 4-5% by weight of a coagulating/hardening agent, 20-30% by weight polyurethane resin and 50-60% of a diluent thinner comprising compounds such as ketones, ethanol, toluene and naphtha.

Of interest to the present invention is the disclosure of PCT/US2006/045167 (the disclosure of which is incorporated herein by reference) directed to a method for manufacturing a plate-type heater comprising a resistant carbon containing (carbonic) heating layer. Specifically, the manufacturing method comprises a step in which the current carrying wire for supplying electricity is fixed to the front of an absorbent fabric. Next, the aforementioned fabric is reversed and a heating material is applied to the entire reverse surface of the fabric. Then, surface components are formed on the top of the heating material and the front of the fabric. PCT/US2006/045167 further describes the step in which, before fixing the current-carrying wire in place, a polyolefin resin is applied (preferably by extrusion coating) over the entire surface of the fabric on which the current carrying wire has been placed in order to fix the wire to the fabric. The heating material is preferably applied by gravure printing.

Also of interest to the present invention is the disclosure of US Application 2008/0264929 (the disclosure of which is hereby incorporated by reference) which is directed to plate type electrical heaters which are designed to allow the uniform generation of heat across the surface of the heater. The heater uses a conductive carbon compound (far infrared radiation conductive ink) which is 30.4% urethane polymer resin, 15.6% conductive powder (such as a carbon polymer), 4% additives (such as an adhesive), and 50% dilute solvent (such as water or a thinner). The devices comprise an upper component composed of a first outer covering and a first intermediate layer joined together and a lower component composed of a second outer covering and a second intermediate layer joined together, with a conductive carbon containing heating element being placed between said upper component and lower component and wires laminated onto the two end surfaces of said heating element.

The application discloses a method for manufacturing of a plate-type heater comprising a step in which an upper component and a lower component composed of joined outer coverings and intermediate layers are manufactured, a step in which a heating element is applied to the upper part of the entire surface of the aforementioned lower component, and a step in which conductive wires used to supply electrical energy are attached by lamination to the ends of the aforementioned heating element, and the aforementioned lower component to which the heating element has been applied and the aforementioned upper component are joined. The heating element comprises a conductive heat producing carbon compound through which electrical current is passed which thereby produces heat.

US Application 2008/0264929 discloses a method for manufacturing a plate-type heater. First, the upper component composed of the first outer covering and the first intermediate layer and the lower component composed of the second outer covering and the second intermediate layer are manufactured. In this case, the first outer covering and second outer covering on the one hand and the first intermediate layer and second intermediate layer on the other, which make up the upper and lower components respectively, are composed of the same materials.

In the first outer covering, resin films composed of polyethylene terephthalate (PET), polypropylene (PP), nylon, or similar materials which show no deformation at temperatures of 150° C. or below, are selected as films because of their durability, heat resistance, transparency, printing properties, etc.

Non-woven fabrics, such as polyethylene, polypropylene, paper or cotton fabrics are selected for use as the first intermediate layer in order to enhance electrical insulating properties and heat retention properties, and increase stability of the heater. These materials usually are used in a width of about 50 cm to about 200 cm, and must show no deformation at temperatures of 150° C. The first outer covering and the first intermediate layer are joined to manufacture the upper component, with the resin used for joining being a polyolefin resin having a melting point of 100 to 170° C., and the resin is melted at 300° C. The extrusion coating is said to be carried out individually, or in combination, to join and manufacture the upper component. The lower component is then joined and manufactured from the second outer covering and the second intermediate layer using the same method. After manufacturing the upper component, which is composed of the outermost covering and the intermediate layer and the lower component, which is spread on the ground during use and carbon compound material (in hardened form) is placed on the surface of the lower component and a second carbon compound, in consideration of its conductivity and heat generation properties, is laminated on by means of gravure printing in accordance with the requirement that the mesh size of the gravure printing roller must be 80#-150#, and the width of the mesh printing surface is adjusted to conform to a desired heating width.

US Application 2008/0264929 further discloses that the printing method conventionally used in manufacturing heaters has been the screen printing method, and because lamination printing is impossible by the screen printing method, high-viscosity ink is used, and after printing by the screen printing method, the outermost covering was attached by the dry lamination method. However, the degree of conductivity and the amount of heat must be adjusted by means of viscosity, and it is very difficult to carry out such adjustments in a precise manner. If the gravure printing method is used in order to compensate for this, as is the case for US Application 2008/0264929 the concentration of the carbon composite compound and the thickness of the laminate must be taken into consideration, and single or multiple lamination can be carried out in accordance with customer requirements and the application in question. More precise adjustments can be made by adjusting the mesh size of the printing roller. It is preferred that the gravure printing method be carried out with a mesh size of 80# to 150#. An important factor in this case is that with a size of 80 mesh or below, the ink will blot, making precise product manufacturing difficult, while at a mesh size of 150 or above, the ink will not provide sufficient coverage, making it impossible to manufacture the product. This is done so that it is possible to adjust the conductivity and amount of heat as needed under any conditions.

Once manufacturing is completed of the upper component and the lower component, to which the carbon compound is applied, the upper component and the lower component are joined to complete the plate-type heater, and a copper plate finished product, optionally having holes drilled in it for burying current-carrying electric wire or current-carrying braided wires having an overall diameter of 2 to 3 mm, or more, preferably 2-2.3 mm, composed of 10 or more strands of thin twisted copper wire, which are attached at the ends, or if necessary in the middle, of the laminated carbon compound, melted with the used polyolefin resin, and joined and completed by the extrusion lamination method.

US Application 2008/0264929 represented an improvement to then existing plate (line) type heaters, namely problems resulting from adhesion to the current-carrying film using a conductive adhesive. Specifically, wires were fixed in place solely by lamination, without using an adhesive, and for this purpose, electric wire having an overall diameter of about 2 to about 3 mm or more (flat strip wire or braided (twisted) thin wire) was processed to compress it into as flat a shape as possible and then used. It was processed into a flat shape in order to make the surface adhering to the application surface of the carbon compound wide, or during manufacturing, to reduce to a minimum any areas protruding from the surface.

Although the width of the plate-type heater must be large, if it is used in cases where high temperature is required, wires having a larger thickness may be used. Either alternating current (AC) or direct current (DC) can be used as a working voltage, with a voltage range of 6 V to 400 V being preferred. Furthermore, conductivity is 0-10², electrical resistance is 0-900Ω, the application thickness of the carbon compound is 10-100 μm, the heat-generating width is 50-200 cm, and the far infrared radiation percentage is 87.5%.

The film heaters of the prior art are subject to breakage due to bending as well as being stepped upon. For example, it is important that the contact between the copper wire (12) and the surface not loosen because of the risk of fire. Prior art devices comprise outer layers composed of Polyethylene terephthalate (PET) or oriented polypropylene (OPP) films but the devices have limited utility for use in locations like floors. In addition, film heaters create strong electric and magnetic fields and it is desired to be able to ground such devices to prevent electrical shock.

Appliances and other electrically powered devices are normally grounded by use of an electrically connective line to ground. Because lines transmitting alternating current (AC) do not have a “positive” or a “negative” line regulations frequently require that an additional conductive line called the earth line be provided as a ground. In some countries, the neutral line has a separate plug for grounding and in many countries earthed-three contact electrical plugged systems are mandatory.

Avoiding such limitations will increase the usefulness of such heaters. Accordingly, there remains a desire for film type heaters with improved flexibility and opportunities for use.

### SUMMARY OF THE INVENTION

The present invention provides a film-type heater with improved stability comprising: an upper component comprising a first outer covering and a first intermediate layer; a lower component comprising a second outer covering and a second intermediate layer; and at least one carbon containing heating element attached to means for applying electrical current which is disposed between said upper component and said lower component; said film-type heater further comprising an electrical grounding element comprising a carbon containing conductor disposed between said carbon containing heating element and at least one of said upper component or lower component.

Conductive carbon (carbonic) films may be used to fabricate both the heating layer(s) and grounding layers of the heaters. A variety of conductive carbon containing heating films may be used with those comprising conductive carbon powder in combination with polymer resins and other elements such as germanium being particularly preferred. Preferred polymer resins for use according to the invention include polyurethane resin but a variety of materials known to those of ordinary skill in the art can also be used. The ability to provide a ground to the film-type heaters while maintaining their flexibility through the use of a conductive carbon ground increases the numbers and types of uses to which the heaters can be applied.

The conductive carbon heating (carbonic) film comprises a blend of carbon black powder in combination with other ingredients including polymeric ingredients such as polyurethane, vinyl and acrylic resins, other coagulants and elements such as germanium and the like. Vinyl and acrylic resins are preferred over polyurethane resins because of their greater physical strength. A preferred formulation comprises from 13-15% by weigh carbon black; 10-15% by weight vinyl resin, 5-10% by weight acrylic resin in combination with various diluents such as ethyl acetate, ethanol, toluene and naphtha to promote dispersion of the other ingredients. After blending, the diluents are removed by evaporation to leave a solid composition comprising the carbon compound and resin.

The proportions of the ingredients can be varied by those of ordinary skill in the art according to the intended use of the device. If a lower wattage is desired the composition can comprise 13% carbon black combined with 15% vinyl and 10% acrylic. Alternatively, if a higher wattage is desired, such as for use in a sauna, the composition can comprise 17% carbon black combined with 10% vinyl and 5% acrylic resin.

The formulation of the conductive carbon heating layer is selected so that the ingredients are readily miscible and it provides resistance to the electrical current in order to generate heat while having durable physical properties. The conductive carbon heating film layers may be manufactured with varying thicknesses but thicknesses of around 40 μm are generally preferred.

A different conductive carbon formulation is used in the manufacture of the carbon grounding layer which preferably uses conductive carbon nano tubes (CNT's). Such carbon nano tubes are less miscible than carbon black but provide excellent electrical conductivity. A useful conductive carbon formulation for manufacture of the grounding layer comprises carbon nano tubes commercially available from Nano Solution Col, Ltd. Korea. The grounding layer need only be thick enough to adequately conduct any electrical charge to ground but a thickness of about 20 μm has been found to be useful.

The first and second outer coverings of the heater preferably comprise synthetic resin films including but not limited to those selected from the group consisting of nylon, polyethylene, polypropylene and polyester resins with polyethylene terephthalate (PET) being a particularly preferred film because of its high melting temperature of around 257° C. which is higher than that of polyurethane which has a melting temperature of under 200° C.

According to one aspect of the invention multiple layers including non-woven fabric layer and plastic film layers are compressed together with carbonic heating and carbon containing grounding layers to produce the film heaters of the invention. The heating layers may be produced from mixtures of carbon and carbon polymer powders with other ingredients such as polymeric resins. According to one formula carbon containing heating layers can be produced using a mixture of 13-17 wt % of carbon powder, 1-2 wt % of germanium, 10-15% vinyl resin, 5-10% acrylic resin, 4-5 wt % of hardener, and 40-60% of a diluent comprising thinner, ethyl acetate, ethanol, toluene and naphtha which is removed by evaporation after blending.

The grounding layers of the invention may be formed in a similar fashion but are intended to provide conductivity and low resistance so utilize highly conductive carbon nano tubes as their carbon powder components. Preferred compositions include those comprising greater than 20% by weight carbon nano tubes, 10-15% by weight vinyl resin, 15-17% by weight acrylic resin, 5% by weight hardener and 50% of a diluent comprising thinner, ethyl acetate, ethanol, toluene and naphtha which is removed by evaporation after blending.

The film-type heaters of the invention can be designed to use electricity at various voltages including 220 volts and 110 volts lower voltages such as 40 volts or less can also be used where desired.

### BRIEF DESCRIPTION OF THE FIGURES

FIG. 1 depicts a cross-sectional view showing the internal fabric of a conventional film heater;

FIG. 2 depicts a cross-sectional view showing the internal fabric of film heater according to the present invention;

FIG. 3 depicts across-sectional view showing another preferred embodiment of a film heater according to the present invention;

FIG. 4 depicts a preferred embodiment of the plane heater; and

FIG. 5 depicts a flowchart showing the manufacturing process of the plane heater.

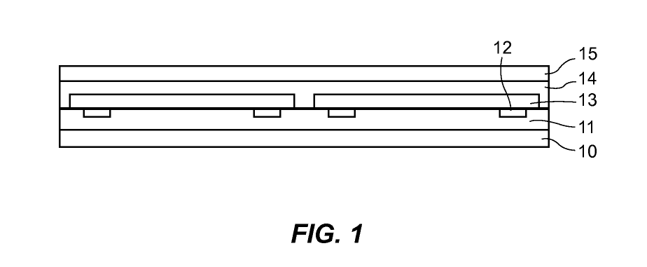

### DETAILED DESCRIPTION

### Example 1

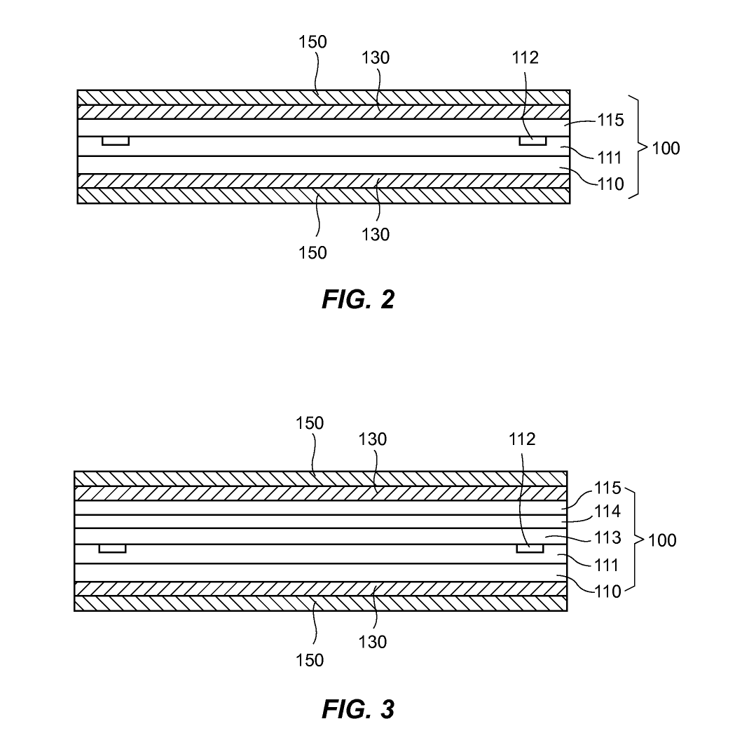

According to this example, FIG. 2 depicts the interior section view of a film heater (100) according to the invention which includes heat sources, cover layer and outer layer. Specifically, the heater comprises a first plastic film (110), first carbon containing heating (carbonic) layer (111) which is located above the first plastic film (110), multiple copper wires (112), and a second plastic film (115). Two carbon containing layers (130) which serve as grounds are disposed below the first plastic film (110) layer and above the second plastic film (115) layer which are connected through wires to a grounding line. Finally, outer layers (150) are provided to the exterior of the grounding layers (130).

### Example 2

According to this example, a film type heater similar to that of FIG. 2 is produced and depicted in FIG. 3 whereby the heat production can be improved by putting second carbon heating layer (114) between non-woven fabric layer (113) and second plastic film (115). Grounding layer (130) is created by carbonic layer on the exterior layer of the heating layers, to prevent electric and magnetic fields and serve as grounds. The carbon used in cover layer (130) has multi-purpose such as absorbing electromagnetic waves, reduce humid, and so on. The principle behind the grounding layer (130) is as follows.

In a similar manner the grounding layer of the device allows electricity to flow around the carbonic layer and grounding it. This will reduce all electric field, magnetic field and electromagnetic waves. For instance, electricity created on the exterior surface of a film-type heater can vary but when it is strong it can get up to 75%. Thus, if a film-type heater is powered with 220 volts electricity the exterior surface of the heater can be charged to as much as 160 volts. This can be reduced to 1 volt or less when grounded according to the invention.

According to one preferred aspect of the invention the grounding layer (130) is made up of 15-17 percent by weight carbon powder, 1-2% by weight germanium, 4-5% by weight of a hardener, 20-30% polyurethane and 50˜60% thinner which can comprise alcohols such as ethanol, ethyl acetate, esters, ketones and the like.

The outer layer (150) comprises a high strength, flexible, and endurable non-woven fabric is attached to the grounding layer (130) to provide more flexibility to the heating film. This allows the outer layer (150) to better resist heat or external physical damage. In this case, the resin film (115) is preferably about 50 polyethylene terephthalate (PET) and the outer layer (150) preferably has a density of from 10 to 200 g/m² with a higher density being preferred to better absorb the sound of the plastic film. The interior non-woven layer (113) preferably has a thickness of about 20 g/m²

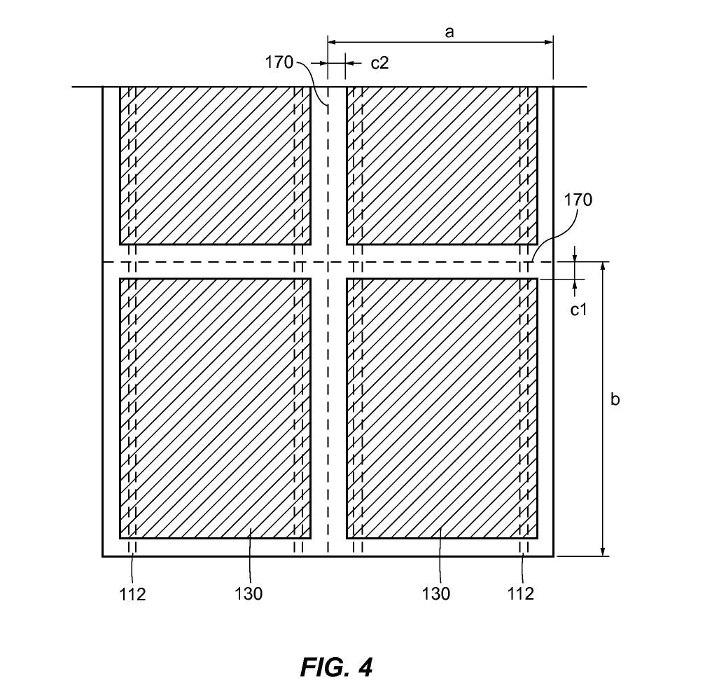

FIG. 4 depicts a further alternative version wherein the film heaters of the invention can be mass produced for use in products like mats or cushions wherein the heaters have vertical and horizontal cutting lines. Specifically the cutting line (170) should be at least 1 to 2 cm (c1) (c2) from the heat source (100) or the cover layer (130) in order to prevent cutting into the electrically conductive areas which can result in an electrical short circuit.

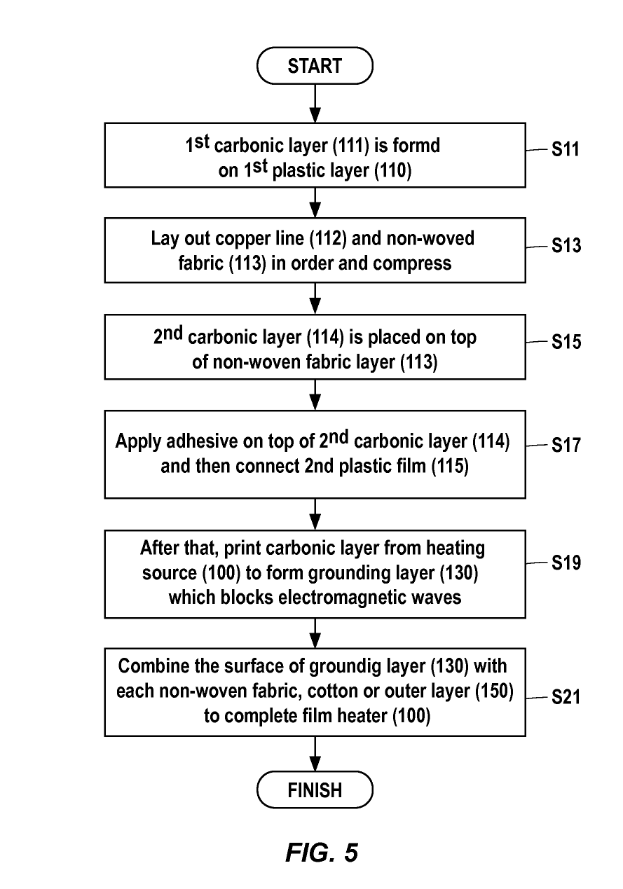

FIG. 5 provides a schematic diagram of how the film heaters of the invention are fabricated comprising two carbonic heating layers (111) and (114). First, a first plastic film (110) is formed with a first carbonic heating layer (111). A copper line (112) is laid out above the first carbonic layer (111) and non-woven fabric (113) and is compressed (S13). A second carbonic heating layer (114) is printed on top of non-woven fabric layer (113) (S15). Adhesive is then applied on top of the second carbonic layer (114) and then connected with a second plastic film (115) together to complete (S17) heating source (100) A carbonic layer is printed to form a grounding layer (130) which blocks electromagnetic waves (S19). Finally, the surface of the grounding layer (130) is covered with each of a non-woven fabric, cotton or outer layer (150) to provide smoothness and flexibility and to complete the film heater-type (100). (S21)

Numerous modifications and variations in the practice of the invention are expected to occur to those skilled in the art upon consideration of the presently preferred embodiments thereof. Consequently, the only limitations which should be placed upon the scope of the invention are those which appear in the appended claims.

What is claimed is:

1. A film-type heater with improved stability comprising:
an upper component comprising a first outer covering and a first intermediate layer;
a lower component comprising a second outer covering and a second intermediate layer;
and at least one carbon containing heating element attached to means for applying electrical current which is disposed between said upper component and said lower component;
said film-type heater further comprising an electrical grounding element comprising a carbon containing conductor disposed between said carbon containing heating element and at least one of said upper component or lower component.

2. The film-type heater of claim 1 wherein the first and second outer coverings comprise synthetic resins.

3. The film-type heater of claim 1 wherein the first and second outer coverings are selected from the group consisting of nylon, polyethylene, polypropylene and polyester.

4. The film-type heater of claim 1 wherein the first and second intermediate layers comprise non-woven fabrics.

5. The film-type heater of claim 1 wherein carbon containing heating element comprises a conductive carbon powder in combination with a polymer resin.

6. The film-type heater of claim 1 wherein the conductive carbon powder is carbon black.

7. The film-type heater of claim 5 wherein the polymer resin is selected from the group consisting of polyurethane, vinyl and acrylic resins.

8. The film-type heater of claim 1 the carbon containing grounding element comprises a conductive carbon powder in combination with a polymer resin.

9. The film-type heater of claim 8 wherein the conductive carbon powder is a carbon nano tube.

10. The film-type heater of claim 8 wherein the polymer resin is a vinyl and/or acrylic resin.
